(19) United States
(12) Patent Application Publication
(10) Pub. No.: US 2010/0053125 A1
(43) Pub. Date: Mar. 4, 2010

(54) DISPLAY DRIVER INTEGRATED CIRCUIT APPARATUS AND METHOD OF OPERATING THE SAME

(75) Inventors: In-suk KIM, Suwon-si (KR); Jae-goo Lee, Yongin-si (KR); Jae-hyuck Woo, Osan-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 12/537,289

(22) Filed: Aug. 7, 2009

(30) Foreign Application Priority Data
Aug. 28, 2008 (KR) 2008-84740

(51) Int. Cl. G09G 5/00

(52) U.S. Cl. 345/204

(57) ABSTRACT

A display driver integrated circuit (IC) apparatus having an improved data transmission characteristic, an electronic apparatus having the same, and a method of operating the same. The display driver IC apparatus includes a memory unit to store data, a logic circuit unit to perform data processing of a plurality of pieces of data that are read by the memory unit through a plurality of data lines, and a switching unit disposed on the plurality of data lines between the memory unit and the logic circuit and comprising transmission gates corresponding to the plurality of data lines, so as to control transmission of the plurality of pieces of data that are read by the memory.

### CROSS-REFERENCE TO RELATED APPLICATIONS

This application claims priority under 35 U.S.C. §119 from Korean Patent Application No. 10-2008-0084740, filed on Aug. 28, 2008, in the Korean Intellectual Property Office, the disclosure of which is incorporated herein in its entirety by reference.

### BACKGROUND

1. Field of the Invention

The inventive concept relates to a display driver integrated circuit (IC), an electronic apparatus having the same, and a method of operating the same, and more particularly, to a display driver IC apparatus having an improved data transmission characteristic and a method of operating the same.

2. Description of the Related Art

In general, liquid crystal display (LCD) devices are widely used as display devices for use in laptop computers, monitors, etc. LCD devices include a panel on which an image is displayed, and a plurality of pixels are disposed on the panel. The plurality of pixels are formed in a region in which a plurality of scan lines through which gate selection signals are transmitted and a plurality of data lines through which color data, i.e., gradation data is transmitted.

Display driver integrated circuits (IC) provide gradation data to the panel through the data lines so that an image can be displayed on the panel. In addition, in the case of a mobile display driver IC for driving a panel disposed in a mobile device, a scan driver for driving the scan lines and a source driver for driving the data lines may be integrated on one chip and designed. Display driver IC may include memory in which data is stored. Display driver IC read data stored in the memory, perform logic processing of the data, and provide gradation data that is generated during logic processing to the panel. An operation related to data transmission of a related display driver IC will be described with reference to FIG. 1.

FIG. 1 is a circuit diagram illustrating a related display driver IC 10 including a memory unit and a Tri-state buffer. Referring to FIG. 1, the related display driver IC 10 includes at least one of first and second memory units 11_1 and 11_2, which store data related to gradation of an image displayed on a panel (not shown), and at least one of buffer units 12_1 and 12_2, which control transmission of a plurality of pieces of data that are read by the first and second memory units 11_1 and 11_2. The buffer units 12_1 and 12_2 may include a predetermined number of Tri-state buffers, wherein the predetermined number corresponds to the number of data ports disposed at the first and second memory units 11_1 and 11_2, so as to provide data to the first and second memory units 11_1 and 11_2. A plurality of pieces of data that are read by the first and second memory units 11_1 and 11_2 in parallel are provided to a logic circuit in a source driver for processing the data via the buffer units 12_1 and 12_2.

The data that are read by the first and second memory units 11_1 and 11_2 are provided to the buffer units 12_1 and 12_2 in parallel, and the buffer units 12_1 and 12_2 output the data in series through a plurality of data lines in response to first control signals CS1 and second control signals CS2. For example, when gradation is realized due to data containing 24 bits (8-bit red (R) color, 8-bit green (G) color, and 8-bit blue (B) color), the buffer units 12_1 and 12_2 may output data that is provided by the first and second memory units 11_1 and 11_2 in parallel, sequentially in 24-bit data (D<0>, D<1>, . . . , D<23>) units.

However, the related display driver IC 10 having the above structure use a Tri-state buffer having a large size so as to transmit data that are read by the first and second memory units 11_1 and 11_2. In order to transmit first 24-bit data D1<0:23> during a data transmission operation, buffers corresponding to the first 24-bit data are enabled, and the other buffers are disabled. However, since n-type metal-oxide-semiconductor (NMOS) transistors and p-type MOS (PMOS) transistors, each having a large size and disposed on the disabled buffers, are connected to the data lines, loads are generated due to parasitic capacitances caused by the NMOS transistor and the PMOS transistors. In addition, metal-to-metal capacitances between the data lines through which data is transmitted are considerably large. As such, loads increase due to the metal-to-metal capacitances.

### SUMMARY

The inventive concept provides a display driver integrated circuit (IC) which improves a data transmission characteristic by reducing loads that are generated in a plurality of data lines, an electronic apparatus having the same, and a method of operating the same.

Additional aspects and utilities of the present general inventive concept will be set forth in part in the description which follows and, in part, will be obvious from the description, or may be learned by practice of the general inventive concept.

According to utilities and features of the inventive concept, there may be provided a display driver integrated circuit (IC), including a memory unit storing data, a logic circuit performing data processing of a plurality of pieces of data that are read by the memory unit through a plurality of data lines, and a switching unit disposed on the plurality of data lines between the memory unit and the logic circuit and comprising transmission gates corresponding to the plurality of data lines, so as to control transmission of the plurality of pieces of data that are read by the memory.

The switching unit may further include inverters disposed to correspond to the transmission gates to receive first control signals used to control the transmission gates and to generate the inverted first control signals.

The memory unit may include m×n output ports to output m×n bit data (where m and n are integers), and the switching unit may include first through n-th switching groups, and each of the first through n-th switching groups may include m transmission gates corresponding to m-bit data, and when one of the first through n-th switching groups is enabled, the transmission gates included in the other switching groups may be turned off.

The memory unit may include m×n output ports to output m×n bit data (where m and n are integers), and the plurality of data lines may include e a plurality of local data lines connected to the output ports of the memory units and global data lines connected between the local data lines and input ports of the logic circuit.

The switching unit may include a first switching unit disposed on the local data lines and comprising transmission gates used to control transmission of the data that are read by the memory unit, and a second switching unit comprising transmission gates to connect the local data lines and the global data lines.

The first switching unit may include n first switching groups, and each of the first switching groups may include m transmission gates corresponding to m-bit data, and the second switching unit may include x (where x is an integer) second switching groups, and each of the second switching groups may include m transmission gates for transmitting the m-bit data.

Each of the second switching groups may be electrically connected to (n/x) switching groups of the n first switching groups, and data that are received from the (n/x) switching groups may be sequentially transmitted to the global data lines.

When one of the n first switching groups is enabled, the other switching groups may be disabled, and when one of the x second switching groups is enabled, the other switching groups may be disabled.

The memory unit may include a plurality of memory, and the global data lines may be electrically connected to the plurality of memory, and the display driver IC may further include buffers disposed on the global data lines and connected between nodes through which data read by first memory are transmitted and nodes through which data read by second memory adjacent to the first memory are transmitted.

The global data lines may include first global data lines, which are not adjacent to one another and are formed as the same metal layer, and second global data lines, which are disposed between the first global data lines and are formed as different metal layers from the first global data lines.

According to utilities and features of the inventive concept, there may also be provided a display driver integrated circuit (IC) for driving a display device, the display driver IC including a memory unit to store data, local data lines connected to data ports of the memory unit, global data lines connected to the local data lines to be switched thereto and providing data that are received through the local data lines to a logic circuit, so that the display device can be driven, a first switching unit disposed on the local data lines and controlling transmission of data that are output from the memory unit, and a second switching unit disposed between the local data lines and the global data lines and transmitting data that are received from the local data lines to the global data lines.

According to utilities and features of the inventive concept, there may also be provided a method of operating a display driver integrated circuit (IC), the method including sequentially enabling first through a-th switching groups (where a is an integer) of a first switching unit and transmitting data that are read by the memory unit through a plurality of local data lines, enabling a first switching group of a second switching unit commonly connected to the first through a-th switching groups of the first switching unit and transmitting data that are received through the local data lines to a plurality of global data lines, and providing the data to a logic circuit for processing of the data through the global data lines.

According to utilities and features of the inventive concept, there may also be provided a display driver integrated circuit apparatus including a memory unit to store data, and having a plurality of groups of ports, each group of ports having a predetermined number of ports to correspond to a predetermined number of bits of the data, the memory unit to output the predetermined number of bits of the data in parallel through each groups of ports and sequentially output the data through the respective groups of ports in a unit of the predetermined number of bits of the data, a first switching unit having a plurality of groups of first switching elements, the each group of first switching elements to receive the predetermined number of bits of the data in parallel from the respective groups of ports of the memory unit and the groups of first switching elements to sequentially transmit the predetermined number of bits of the data, and a second switching unit having a second switching element to selectively receive the data of the predetermined number of bits from the respective groups of first switching elements of the first switching unit, and to transmit the received data of the predetermined number of bits in parallel.

The memory unit may include a plurality of another groups of another ports, each group of ports having a predetermined number of ports to correspond to a predetermined number of bits of the data, the memory unit to output the predetermined number of bits of the data in parallel through each of another groups of another ports and sequentially output the data through the respective ones of another groups of another ports in a unit of the predetermined number of bits of the data. The first switching unit may include a plurality of another groups of first switching elements, the each of another groups of first switching elements to receive the predetermined number of bits of the data in parallel from the respective ones of anther groups of another ports of the memory unit, and the another groups of first switching elements to sequentially transmit the predetermined number of bits of the data. The second switching unit may include a second switching element to selectively receive the data of the predetermined number of bits from the respective groups of another switching elements of the first switching unit, and to transmit the received data of the predetermined number of bits in parallel.

According to utilities and features of the inventive concept, there may also be provided a display driver integrated circuit apparatus, including a memory unit to store data, and having a plurality of groups of ports, a first switching unit having a plurality of groups of first switching elements to receives the predetermined number of bits of the data in parallel from the respective groups of ports of the memory unit, and to sequentially transmit the predetermined number of bits of the data, local data lines to connect the respective ports of the memory unit to the corresponding first switching elements of the first switching unit; a second switching unit to selectively receive the data of the predetermined number of bits from the respective groups of first switching elements of the first switching unit, and to transmit the received data of the predetermined number of bits in parallel, and global data lines connected to the second switching unit to transmit the data received from the second switching unit in parallel.

According to utilities and features of the inventive concept, there may also be provided a display driver apparatus including a memory unit to store data, and having a plurality of ports to output the date, and a switching unit to receive data of a predetermined bits from each group of ports in parallel, to sequentially receive each parallel data of predetermined bits from respective groups of ports, and to selectively output the sequentially received parallel data of the predetermined bits.

The switching unit may include a first switching unit to receive data of a predetermined bits from each group of ports in parallel, to sequentially receive each parallel data of predetermined bits from respective groups of ports, and a second switching unit to selectively output the sequentially received parallel data of the predetermined bits. The first switching unit and the second switching unit may be connected in series from the memory unit through corresponding data lines.

The display driver apparatus may further include local data lines connected between the memory and the first switching unit, and another data lines connected between the local data lines and the second switching unit,

The local data lines may not overlap each other, and the another data lines may overlap each other.

The local data lines may be disposed on a same layer, and the another data lines may be disposed on different layers, with respect to the memory unit.

According to utilities and features of the inventive concept, there is provided a display apparatus, including a display driver integrated circuit apparatus having a memory unit to store data, and having a plurality of ports to output the date, and a switching unit to receive data of a predetermined bits from each group of ports in parallel, to sequentially receive each parallel data of predetermined bits from respective groups of ports, and to selectively output the sequentially received parallel data of the predetermined bits, a source driving unit to generate image data according to the data from the global data lines, and a display panel to display an image according to the image data.

### BRIEF DESCRIPTION OF THE DRAWINGS

Exemplary embodiments of the present general inventive concept will be more clearly understood from the following detailed description taken in conjunction with the accompanying drawings in which

FIG. 1 is a circuit diagram illustrating a conventional display driver integrated circuit (IC) including a memory unit and a Tri-state buffer;

FIG. 2 is a block diagram illustrating a display driver IC apparatus according to an embodiment of the present general inventive concept;

FIG. 3 illustrates configuration of a plurality of data lines of a display driver IC including a plurality of memory units, according to an embodiment of the present general inventive concept;

FIG. 4 is a circuit diagram illustrating the buffer unit of FIG. 3 and a plurality of global data lines, according to an embodiment of the present general inventive concept;

FIG. 5 is a circuit diagram illustrating the display driver IC apparatus illustrated in FIG. 2, according to an embodiment of the present general inventive concept;

FIG. 6 is a block diagram illustrating a display driver IC apparatus according to an embodiment of the present general inventive concept; and

FIG. 7 is a diagram illustrating an electronic apparatus according to an embodiment of the present general inventive concept.

### DETAILED DESCRIPTION OF THE EMBODIMENTS

The attached drawings for illustrating exemplary embodiments of the inventive concept are referred to in order to gain a sufficient understanding of the inventive concept, the merits thereof, and the objectives accomplished by the implementation of the inventive concept. Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

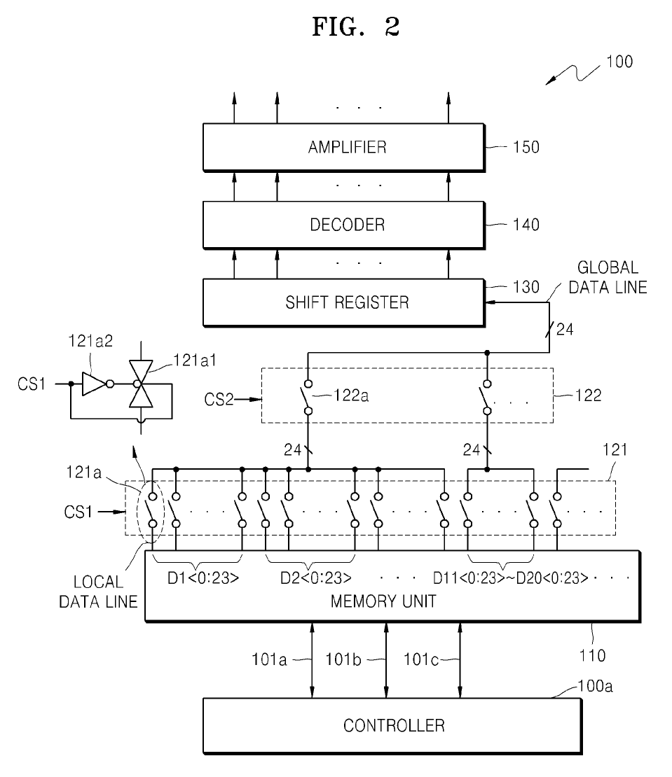

FIG. 2 is a block diagram illustrating a display driver integrated circuit (IC) apparatus 100 according to an embodiment of the present general inventive concept. Referring to FIG. 2, the display driver IC apparatus 100 may include a memory unit 110, which stores data related to gradation of an image displayed on a panel (not illustrated), at least one of switching units 121 and 122, which switch the data that are read by the memory unit 110 and control transmission of the data, and at least one of logic circuits 130, 140, and 150, which perform processing of the data provided through a plurality of data lines. For example, the at least one of logic circuits 130, 140, and 150, which perform data processing, may include a shift register 130, a decoder 140, and an amplifier 150. The shift register 130, the decoder 140, and the amplifier 150 constitute a source driver (or source driving unit) in the display driver IC apparatus 100 to provide data the panel to display an image on a screen thereof according to the provided data.

Although FIG. 2 illustrates a single memory unit 110, the present general inventive concept is not limited thereto. The display driver IC apparatus 100 may include a plurality of memory units. For example, when the display driver IC apparatus 100 drives a quarter video graphics array (QVGA) panel with, for example, 320×240 resolution and includes four memory units and gradation is realized due to data containing, for example, 24 bits (for example, 8-bit red (R) color, 8-bit green (G) color, and 8-bit blue (B) color), each of the memory units may store data containing, for example, 1440 bits (60×24) per row. The configuration related to the values may be changed due to various reasons, such as resolution of a panel to be driven and the number of memory units disposed in the display driver IC apparatus 100.

The memory unit 110 outputs data (for example, data containing 1440 bits) stored in each row in response to a predetermined read operation. The at least one of switching units 121 and 122 is disposed between the memory unit 110 and the logic circuits 130, 140, and 150 and controls transmission of the data. As described above, the logic circuits 130, 140, and 150 may constitute a source driver in the display driver IC apparatus 100, and the at least one of switching units 121 and 122 may be disposed in the source driver or outside the source driver.

The at least one of switching units 121 and 122 may include a first switch unit 121 and a second switch unit 122. The first switch unit 121 includes a plurality of switches 121a, which are disposed on a plurality of local data lines connected to data ports of the memory unit 110 and control transmission of data. In particular, each of the switches 121a includes a transmission gate 121a1 having a small size, instead of using a Tri-state buffer having a large size so as to improve a driving capability. In addition, in order to control transmission gates 121a1 disposed in each of the switches 121a, an inverter 121a2 may be disposed to correspond to each of the transmission gates 121a1. In order to control the first switch unit 121, at least one of first control signals CS1 is supplied to the first switch unit 121, and switching of each of the transmission gates 121a1 is controlled in response to the corresponding first control signals CS1 and signals that are obtained by inverting the first control signals CS1.

The second switch unit 122 performs a control operation so as to provide the data that is transmitted by the first switch unit 121 to a plurality of global data lines. The second switch unit 122 may control transmission of the data in response to at least one of second control signals CS2. The data that is transmitted to the global data lines is converted by at least one logic circuit into gradation data that is used to drive the panel. For example, the data may be transmitted to the shift register 130 in the source driver through the global data lines.

An operation of the display driver IC apparatus 100 having the above structure, according to an embodiment will be described below in details.

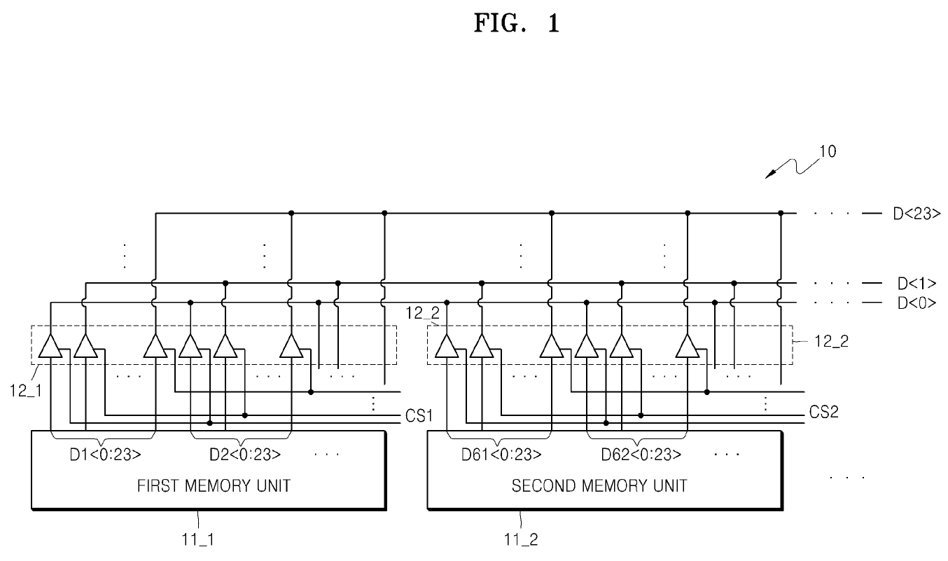

As a predetermined command signal 101a and a predetermined address signal 101b are provided for a read operation of the memory unit 110, data corresponding to one row of the memory unit 110 is read by the memory unit 110. The data may be received from a controller 100a through a data line 101a to be stored in the memory unit 110. It is possible that another memory unit is connected to the memory unit 110 such that the data is transmitted from the another memory unit to the memory unit 110 to store therein. The memory unit 110 may include m×n output ports so as to output m×n bit data corresponding to one row. In FIG. 1, for example, when one color is displayed on a panel (not illustrated) due to data containing 24 bits (8-bit R color, 8-bit G color, and 8-bit B color), the memory unit 110 includes an output port corresponding to a plurality of pieces (60) data D1<0:23> to D60<0:23> each containing 24 bits.

The data that are read (output) by the memory unit 110 are transmitted through a plurality of local data lines. The data that are read by the memory unit 110 are provided to the first switch unit 121 in parallel. Then, the data are sequentially provided in predetermined bit units to a logic circuit (for example, to the shift register 130) via the first switch unit 121 and the second switch unit 122.

The first switch unit 121 may include switches 121a disposed on each of the local data lines, and each of the switches 121a may include a transmission gate 121a1 and an inverter 121a2, as described above. The transmission gate 121a1 is switched in response to the first control signals CS1 and signals that are obtained by inverting the first control signals CS1. The second switch unit 122 is connected between the local data lines and the global data lines and transmits the data that is provided by the first switch unit 121 to the global data lines. Each of the switches of the second switch unit 122 may include a transmission gate and an inverter which are similar to or same as the transmission gate 121a1 and the inverter 121a2, respectively. The transmission gate disposed at the second switch unit 122 may be switched in response to the second control signals CS2 and signals that are obtained by inverting the second control signals CS2.

First, switches 121a corresponding to first 24-bit data among the switches 121a of the first switch unit 121 are turned on. As such, first 24-bit data D1<0:23> among the pieces of data D1<0:23> to D60<0:23> that are provided to the first switch unit 121 in parallel, is provided to the second switch unit 122, and the first 24-bit data D1<0:23> is transmitted to the global data lines during a switching operation of the second switch unit 122. Subsequently, switches 121a corresponding to second 24-bit data D2<0:23> data among the switches of the first switch unit 121 are turned on. As such, the second 24-bit data D2<0:23> is transmitted to the global data lines via the first switch unit 121 and the second switch unit 122. The above operation is performed on all of a plurality of pieces of data (for example, first 24-bit data D1<0:23> to 60^{th} 24-bit data D60<0:23>) that are read by the memory unit 110.

In particular, according to an embodiment, switches 121a of the first switch unit 121 are grouped into a predetermined number, and switches 122a of the second switch unit 122 are grouped into a predetermined number. For example, with respect to the switches 121a of the first switch unit 121, twenty four (24) switches 122a corresponding to twenty four (24)-bit data of eight (8)-bit R color, 8-bit G color, and 8-bit B color are set to one switching group. When a first switching group is enabled so as to transmit the first 24-bit data D1<0:23>, the other switching groups are disabled. Similarly, when any one 24-bit data is transmitted, a switching group corresponding to the 24-bit data is enabled, and the other switching groups are disabled.

With respect to switches 122a of the second switch unit 122, switches 122a having the same number as the number of switches 121a of the first switch unit 121, which are included in one switching group, are set to one switching group. The first switch unit 121 may have a larger number of switching groups than the second switch unit 122. As such, each of the switching groups of the second switch unit 122 is connected to at least two or more switching groups of the first switch unit 121. In FIG. 1, ten (10) switching groups of the first switch unit 121 are connected to one switching group of the second switch unit 122. Like in the first switch unit 121, one switching group of the second switch unit 122 is enabled, the other switching groups are disabled.

An operation of the display driver IC according to an embodiment will now be described in consideration of the above-described switching group.

First, a first switching group of the first switch unit 121 is enabled, and the other switching groups thereof are disabled in response to the first control signals CS1 that are used to control the first switch unit 121. As such, the first 24-bit data D1<0:23> is transmitted to the second switch unit 122.

In addition, a first switching group of the second switch unit 122 is enabled, and the other switching groups thereof are disabled in response to the second control signals CS2 that are used to control the second switch unit 122. As such, the first 24-bit data D1<0:23> is transmitted to the global data lines via the second switch unit 122. The first switching group of the second switch unit 122 may be electrically connected to first through 10^{th} switching groups of the first switch unit 121, and when the first through 10^{th} switching groups of the first switch unit 121 are sequentially enabled, the first switching group of the second switch unit 122 is enabled.

Subsequently, as the second switching group of the first switch unit 121 is enabled, second 24-bit data D2<0:23> is transmitted to the second switch unit 122, and the second 24-bit data D2<0:23> is transmitted to the global data lines through the first switching group of the second switch unit 122. According to the above manner, a third 24-bit data D3<0:23> through 10^{th} 24-bit data D10<0:23> are sequentially transmitted to the global data lines through a corresponding switching group of the first switch unit 121 and the first switching group of the second switch unit 122.

In addition, the second switching group of the second switch unit 122 may be electrically connected to 11^{th} through 20^{th} switching groups of the first switch unit 121. When the 11^{th} through 20^{th} switching groups of the first switch unit 121 are sequentially enabled, the second switching group of the second switch unit 122 is enabled. The 11^{th} 24-bit data D11<0:23> through 20^{th} 24-bit data D20<0:23> are sequentially transmitted to the global data lines through the corresponding switching group of the first switch unit 121 and the second switching group of the second switch unit 122.

When an operation of transmitting data to the memory unit 110 is completed in the above manner, an operation of transmitting data to a memory unit (not illustrated), which may be provided in addition to the memory unit 110, is performed. As such, a display operation is performed on one line of the panel is performed and the display operation is completed on the one line of the panel, a read operation of the memory unit 110 and an operation of transmitting the read data are repeatedly performed so that a display operation can be performed on the next line of the panel.

According to the above configuration, loads that are generated in a data line when the data that are read by the memory unit 110 is transmitted may be reduced, and power consumption that occurs during data driving may be reduced. In other words, all of Tri-state buffers connected to data ports of the memory unit 110 may act as loads in the data line. However, a switch connected to part of the data ports of the memory unit 110 acts as a load in the data line, as illustrated in FIG. 2.

As described above, the display driver IC apparatus 100 includes a memory unit having a plurality of ports to output a plurality of bits, respectively, and a plurality of local data lines connected to the respective ports to transmit the respective bits. The ports and local data lines are formed as a number of groups. Each group may have the same number (a predetermined number) of ports and local data lines among the plurality of ports and the plurality of local data lines. The groups may be disposed along a line, in order, or in series with respect to the memory unit. The groups may be selected sequentially, selectively, in order, or in series according to first control signals such that a selected group can transmit a predetermined number of data bits in parallel (or simultaneously) through the corresponding ports and local data lines. The groups may not overlap with respect to the memory unit, and the local data lines may not overlap each other with respect to the ports.

The display driver IC apparatus 100 further include a plurality of first switches disposed in the respective local data lines to be operable according to the first control signals such that the above-describe first data transmitting operation is performed using the plurality of ports, local data lines, and first switches.

The display driver IC apparatus 100 further include a second switching unit connected to the plurality of the local data lines through another local data lines. The number of the plurality of the local data lines is calculated from the predetermined number multiplied by the number of groups. The number of the another local data lines is the same as the predetermined number of data bits of each group, and the second switching unit may have the same number of the another local data lines to correspond to the predetermined number.

Accordingly, the another local data lines are commonly connected to the respective groups of the ports and local data lines. Each of the another local data lines is connected to corresponding ones of the local data lines of the respective groups, and each of the another local data lines receives a data bit of the predetermined number of data bits from a selected one of the local data lines of each group. The second switching unit receives a predetermined number of data bits from a selected one of the groups and transmits the received predetermined number of data bits to the source driving unit.

Therefore, the first switching unit and the second switching unit are disposed in series with respect to the another local data lines. The local data lines may not overlap each other. However, it is possible the another local data lines connected between the first switching unit and the second switching unit may overlap each other since the number of the another local data lines and the number of the second switches are different from the number of the first switches and the number of the local data lines of the first and second groups.

The ports and local data lines may be formed as a number of first groups and a number of second groups. The first groups are sequentially or selectively selected according to first control signals such that each of the selected first group can transmit data bits in parallel (or simultaneously) through the corresponding ports and local data line. The respective first groups may not simultaneously transmit data bits. For example, a first selected first group simultaneously transmits the data bits, and then a second elected first group simultaneously transmits the data bits while the first selected first group does not transmit the data bits. The second groups are sequentially or selectively selected according to first control signals such that each of the selected second group can transmit data bits in parallel (or simultaneously) through the corresponding ports and local data lines. The respective second groups may not simultaneously transmit data bits. For example, a first selected second group simultaneously transmits the data bits, and then a second elected second group simultaneously transmits the data bits while the first selected second group does not transmit the data bits.

The display driver IC apparatus 100 further include a plurality of first switches disposed in the respective local data lines of the first and second groups to be operable according to the first control signals such that the above-describe first data transmitting operation is performed using the plurality of ports, local data lines, and first switches.

The display driver IC apparatus 100 further include a second switching unit having second switches each connected to the plurality of the local data lines through another local data lines in the first groups and the plurality of the local data lines through another local data lines in the second groups, respectively. Each of the second switches corresponds to the first groups or the second groups. The second switches may have the same predetermined number of the data bits and connected to corresponding ones of the second switches such that the predetermined number of the data bits can be received from a selected one of the second switches to correspond to one of the first groups and the second groups.

The another local data lines are commonly connected to the respective first groups of the ports and local data lines or the respective second groups of the ports and local lines. Each of the another local data lines is connected to corresponding ones of the local data lines of the respective first or second groups, and each of the another local data lines receives a data bit of the predetermined number of data bits from a selected one of the local data lines of each first or second group. The second switching unit receives a predetermined number of data bits from a selected one of the first or second groups and transmits the received predetermined number of data bits to the source driving unit.

The global data lines may have the same predetermined number of the data bits and connected to corresponding ones of the second switches to receive the predetermined number of the data bits from a selected one of the second switches to correspond to one of the first groups and the second groups.

The local data lines may not overlap each other. The local data lines may be disposed on a same layer or a same plane with respect to the memory unit. However, it is possible that another local data lines are disposed in different layers or different planes with respect to the local data lines or the memory unit.

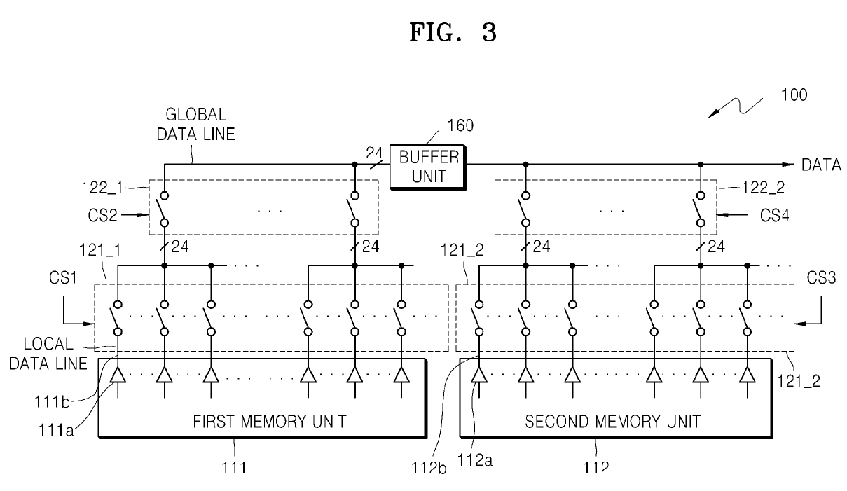

FIG. 3 illustrates configuration of a plurality of data lines of a display driver IC apparatus including a plurality of memory units, according to an embodiment of the present general inventive concept. The same reference numerals of FIG. 3 as those of FIG. 2 denote the same function and thus, a detailed description thereof will be omitted.

Two memory units 111 and 112 are illustrated in FIG. 3. However, the display driver IC apparatus 100 may include two or more memory units. For example, a first switching unit 121_1 connected to the first memory unit 111 includes a predetermined number of switches, wherein the predetermined number corresponds to the number of data ports disposed at the first memory unit 111. As described above, each of the switches may include a transmission gate and an inverter. The first switching unit 121_1 transmits data containing a predetermined bit (for example, data containing 24 bits) to the second switching unit 122_1 in response to the first control signals CS1. One switching group of the second switching unit 122_1 is electrically connected to at least two switching groups of the first switching unit 121_1. The switching group of the second switching unit 122_1 provides data transmitted through the first switching unit 121_1 to the global data lines in response to the second control signals CS2.

Similarly, the first switching unit 121_2 connected to the second memory unit 112 also includes a predetermined number of switches, wherein the predetermined number corresponds to the number of data ports disposed at the second memory unit 112. In addition, the second switching unit 122_2 that is disposed to correspond to the second memory unit 112 includes at least one switching group. In addition, one switching group of the second switching unit 122_2 is electrically connected to at least two switching groups of the first switching unit 121_2. The switching group of the second switching unit 122_2 provides data transmitted through the first switching unit 121_2 to the global data lines. In addition, switching of the first switching unit 121_2 corresponding to the second memory unit 112 may be controlled according to third control signals CS3, and switching of the second switching unit 122_2 may be controlled according to fourth control signals CS4.

Referring to FIG. 3, the memory units 111 and 112 include buffers 111a and 112a disposed to correspond to data ports 111b and 112b, so as to improve a loading capability of output data. In addition, as described above, the display driver IC apparatus 100 according to an embodiment has a structure in which switches of the first switch units 121_1 and 121_2 and the second switch units 122_1 and 122_2 are grouped and a plurality of switching groups of the first switch units 121_1 and 121_2 are connected to one switching group of the second switch units 122_1 and 122_2. By using the above structure, the number of elements that act as loads during data transmission may be reduced. As such, data may be driven by using the buffers disposed in the memory units 111 and 112, and a Tri-state buffer having a large size does not need to be used as an element for switching data output from the memory units 111 and 112.

The display driver IC apparatus 100 according to the current embodiment may further include a buffer unit 160 disposed on the global data lines. The buffer unit 160 may be disposed between the first memory unit 111 and the second memory unit 112 on the global data lines. When the display driver IC apparatus 100 includes a larger number of memory units, the buffer unit 160 may be further disposed between the memory units.

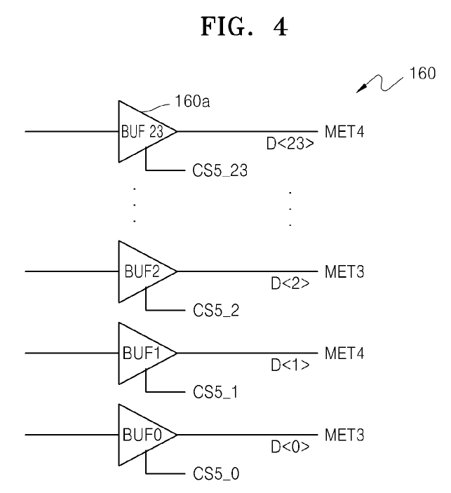

FIG. 4 is a circuit diagram of the buffer unit 160 illustrated in FIG. 3 and a plurality of global data lines, according to an embodiment. Referring to FIG. 4, data that are read by one or more memory units are in predetermined bit (for example, 24-bit) data units sequentially provided to a logic circuit through the global data lines.

The buffer unit 160 may include a predetermined number of buffers 160a, wherein the predetermined number corresponds to the number of the global data lines. Each of the buffers 160a is disposed in each of the global data lines and outputs input data. As such, although a data path between a predetermined memory unit and a logic circuit is long, the driving capability of the data can be improved due to operations of the buffers 160a of the buffer unit 160 so that a change of a level of data provided to the logic circuit can be prevented.

In addition, when a data read operation of the first memory unit 111 is completed and data is read (output) by the second memory unit 112, the buffer unit 160 disposed between the first memory unit 111 and the second memory unit 112 is disabled. As such, when data that are read by the second memory unit 112 are transmitted through the global data lines without the buffer unit 160, loads that may be generated due to the first memory unit 111 and switching elements connected to the first memory unit 111 are prevented during a data reading operation of the second memory unit 112. When a data read operation of the second memory unit 112 is completed, and data of a third memory unit (not illustrated) which may be disposed adjacent to the second memory unit 112 to be connected to the global data lines is read, another buffer unit disposed between the second memory unit 112 and a third memory unit (not illustrated) is disabled. In addition, an operation of the buffer unit 160 may be controlled due to control signals CS5 separately from control signals that are used to control the first switching units 121_1 and 121_2 and the second switching units 122_1 and 122_2.

As described above, data that are read (output) by one or more memory units in parallel may be in predetermined bit (for example, 24-bit) data units sequentially transmitted to the logic circuit through the global data lines. As illustrated in FIG. 4, the global data lines may include the number of metal lines corresponding to the number of the data containing the predetermined bits. According to an embodiment, in order to reduce loads caused by parasitic capacitances generated between the global data lines, at least one global data line is disposed in a different layer from another global data lines. The adjacent global data lines are disposed in different layers so that parasitic capacitances generated between the adjacent global data lines can be reduced. For example, metal lines that constitute global data lines through which odd-numbered data D<0>, D<2>, D<4>, . . . of the data containing 24 bits are transmitted, and metal lines that constitute global data lines through which even-numbered data D<1>, D<3>, D<5>, . . . of the data containing 24 bits are transmitted are disposed in different layers. The metal lines may be made of metal, and may be conductive lines.

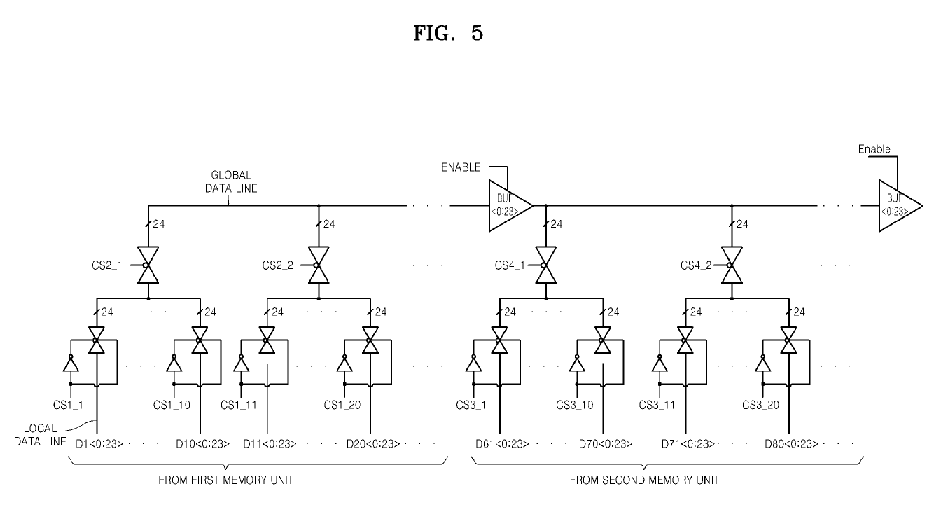

FIG. 5 is a circuit diagram illustrating the display driver IC apparatus of FIG. 2, according to an embodiment. Referring to FIG. 5, switches of a first switching unit receive data that are read by a memory unit and control transmission of the data. For convenience of the drawings, one transmission gate and one inverter are illustrated to correspond to data containing 24 bits (for example, first 24-bit data D1<0:23>). However, one transmission gate and one inverter are disposed to correspond to one bit data. In addition, a transmission gate is illustrated in a second switching unit. However, an inverter that inverts second control signals CS2 or fourth control signals CS4 may be disposed to correspond to the transmission gate, so as to control the second switching unit.

The data (for example, D1<0:23> through D60<0:23>) that are read (output) by the first memory unit are provided to first through 60^{th} switching groups of the first switching unit in parallel, and each of the first through 60^{th} switching groups of the first switching unit is sequentially enabled. As the first through 10^{th} switching groups of the first switching unit are sequentially enabled, the first switching group of the second switching unit connected to the first switching unit is enabled. As such, the data D1<0:23> through D10<0:23> are in 24-bit data units sequentially transmitted to the global data lines through the first switching group of the second switching unit.

By performing the above operation, the 11^{th} through 20^{th} switching groups of the first switching unit are sequentially enabled, and the second switching group of the second switching unit is enabled. As such, the data D11<0:23> through D20<0:23> are in 24-bit data units sequentially transmitted to the global data lines through the second switching group of the second switching unit.

After the data that are read (output) by the first memory unit are transmitted to the global data line, an operation of transmitting data that are read by the second memory unit is performed. In this case, the buffer unit disposed on the global data lines between the first memory unit and the second memory unit is disabled. The data that are read by the second memory unit are sequentially transmitted to the global data lines through a corresponding switching group of the first switching unit and a corresponding switching group of the second switching unit.

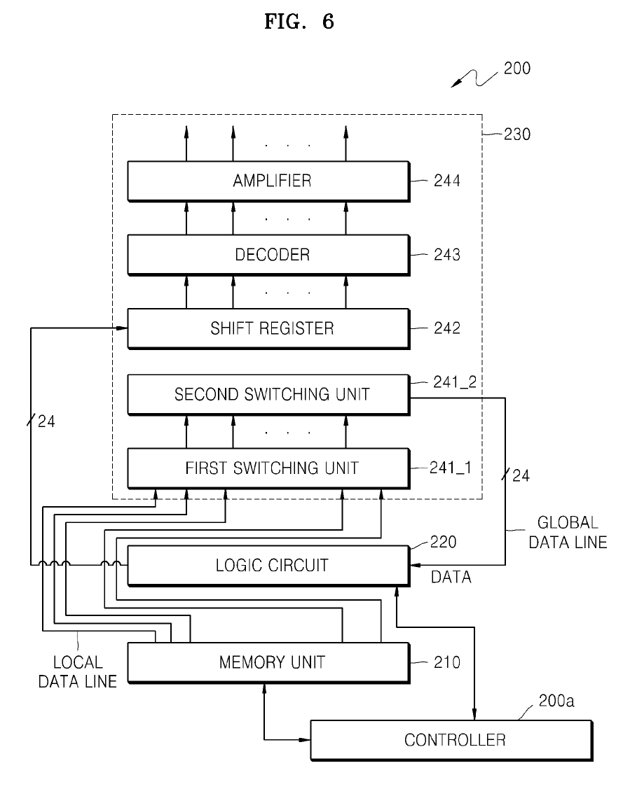

FIG. 6 is a block diagram of a display driver IC apparatus 200 according to another embodiment. Referring to FIG. 6, the display driver IC apparatus 200 may include a memory unit 210, which stores data related to gradation, a logic circuit 220, which processes data that are read by the memory unit 210 in parallel and that is input in predetermined bit units in series to be appropriate to a characteristic of a panel (not shown) to be driven by the display driver IC 200, and a source driver 230, which generates gradation data that is used to drive the panel by using the data that is processed by the logic circuit 220.

In addition, the source driver 230 includes a first switching unit 241_1 including transmission gates and inverters corresponding to each of data bits, and a second switching unit 241_2 including one or more transmission gates and inverters so as to receive data to be transmitted by the first switching unit 241_1 and to transmit the received data to global data lines. In addition, the source driver 230 may further include a source driving unit having a shift register 242, which sequentially receives data from the logic circuit 220 and outputs the received data in parallel, a decoder 243, which converts the digital data that is provided by the shift register 242 into an analog signal, and an amplifier 244, which amplifies the analog signal that is provided by the decoder 243 and outputs the amplified analog signal as the gradation data.

A detailed circuit configuration and an operation of the first switching unit 241_1 and the second switching unit 241_2 are the same as or similar to those of FIGS. 2 through 5 and thus, a detailed description thereof will be omitted. In addition, in the current embodiment illustrated in FIG. 6, the first switching unit 241_1 and the second switching unit 241_2 are provided to the source driver 230. However, the first switching unit 241_1 and the second switching unit 241_2 may be disposed outside the source driver 230.

The first switching unit 241_1 receives the data that are read by the memory unit 210 in parallel and sequentially outputs the data in predetermined bit number units to the second switching unit 241_2. The second switching unit 241_2 transmits data that are sequentially provided by the first switching unit 241_1 to the global data lines in connection with the switching operation of the first switching unit 241_1. Data is input to the logic circuit 220 in series through the global data lines. The logic circuit 220 performs a data processing operation that is previously set to be appropriate to a characteristic of a panel to be driven by the display driver IC apparatus 200 and provides the logic-processed data to the source driver 230. The logic-processed data may be sequentially provided to the shift register 242 of the source driver 230. The shift register 242 provides data corresponding to one line of the panel to the decoder 243 in parallel based on the shifting and storage operations of the data provided sequentially. Due to the gradation data that is generated by performing decoding and amplification operations of the data provided in parallel, an image as gradation corresponding to the gradation data is displayed on the panel.

A controller 200a may control the logic circuit 220 to process the data received through the global data line and to provide the processed data to the source driving unit. The controller may generate signals to control the memory unit 210 and first and second switching units 241 (241-1 and/or 241-2) such that data is stored in the memory unit 210 and is output to the first and second switching units 241 (241-1 and/or 241-2). The logic circuit 220 may be disposed between the memory unit 210 and the first and second switching units 241 (241-1 and/or 241-2). It is possible that the logic circuit 220 may be disposed on a layer different from a layer on which at least one of the memory unit 210 and the first and second switching units 241 (241-1 and/or 241-2) is disposed.

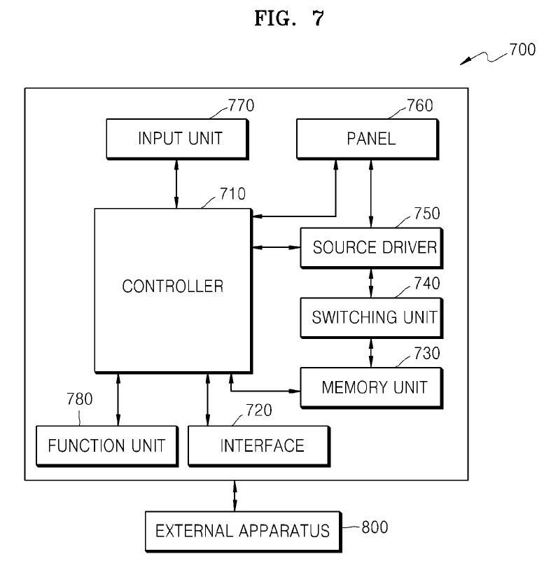

FIG. 7 is a diagram illustrating an electronic apparatus 700 according to an embodiment of the present general inventive concept. The electronic apparatus 700 may be a display apparatus, a portable display and/or computer apparatus, a mobile telecommunication apparatus, etc. The electronic apparatus 700 may include a controller 710, an interface to communicate with an external apparatus 800 through a wired or wireless communication line to transmit or receive data or a command to perform an operation of the electronic apparatus 700, a memory unit 730 to store data, a switching unit 740 to receive a group of data output from the memory unit 730 in parallel and to selectively transmit groups of the received parallel data, a source driver 750 to output image data according to the data, a panel 760 to display an image according to the output image data, an input unit 770 to input data or command to perform an operation of the electronic apparatus 700, and a function unit 780 to perform at least one of operations of the electronic apparatus 700 according to data and/or command input from the input unit 770 and/or the external apparatus 800.

The memory unit 730, the switching unit 740, and/or the source driver 750 may constitute a display driver IC apparatus of the electronic apparatus 700. The display driver IC apparatus 100 or 200 illustrated in FIGS. 1 through 6 may be used as a display driver IC apparatus of the electronic apparatus 700. The operations of the electronic apparatus 700 may be generating data to be displayed on a screen of the panel 760, processing data to be used in the function unit 780, communicating with the external apparatus 800 for data transmitting and receiving, performing a function of the electronic apparatus, etc. However, the present general inventive concept is not limited thereto. The operation of the electronic apparatus 700 may be a method of processing audio and/or video data to generate an image and/or a sound signal.

While the present general inventive concept has been particularly shown and described with reference to exemplary embodiments thereof, it will be understood that various changes in form and details may be made therein without departing from the spirit and scope of the following claims.

What is claimed is:

1. A display driver integrated circuit (IC) apparatus, comprising:
a memory unit to store data;
a logic circuit to perform data processing of a plurality of pieces of data that are read by the memory unit through a plurality of data lines; and
a switching unit disposed on the plurality of data lines between the memory unit and the logic circuit and comprising transmission gates corresponding to the plurality of data lines, so as to control transmission of the plurality of pieces of data that are read by the memory.

2. The display driver IC of claim 1, wherein the switching unit further comprises inverters disposed to correspond to the transmission gates, receiving first control signals used to control the transmission gates and generating the inverted first control signals.

3. The display driver IC of claim 1, wherein the memory unit comprises m×n output ports for outputting m×n bit data (where m and n are integers), and the switching unit comprises first through n-th switching groups, and each of the first through n-th switching groups comprises m transmission gates corresponding to m-bit data, and when one of the first through n-th switching groups is enabled, the transmission gates included in the other switching groups are turned off.

4. The display driver IC of claim 1, wherein the memory unit comprises m×n output ports for outputting m×n bit data (where m and n are integers), and the plurality of data lines comprise a plurality of local data lines connected to the output ports of the memory units and global data lines connected between the local data lines and input ports of the logic circuit.

5. The display driver IC of claim 4, wherein the switching unit comprises:
a first switching unit disposed on the local data lines and comprising transmission gates used to control transmission of the data that are read by the memory unit; and
a second switching unit comprising transmission gates for connecting the local data lines and the global data lines.

6. The display driver IC of claim 5, wherein the first switching unit comprises n first switching groups, and each of the first switching groups comprises m transmission gates corresponding to m-bit data, and the second switching unit comprises x (where x is an integer) second switching groups, and each of the second switching groups comprises m transmission gates for transmitting the m-bit data.

7. The display driver IC of claim 6, wherein each of the second switching groups is electrically connected to (n/x) switching groups of the n first switching groups, and data that are received from the (n/x) switching groups are sequentially transmitted to the global data lines.

8. The display driver IC of claim 7, wherein, when one of the n first switching groups is enabled, the other switching groups are disabled, and when one of the x second switching groups is enabled, the other switching groups are disabled.

9. The display driver IC of claim 4, wherein the memory unit comprises a plurality of memory, and the global data lines are electrically connected to the plurality of memory, and the display driver IC further comprises buffers disposed on the global data lines and connected between nodes through which data read by first memory are transmitted and nodes through which data read by second memory adjacent to the first memory are transmitted.

10. The display driver IC of claim 4, wherein the global data lines comprise:
first global data lines, which are not adjacent to one another and are formed as the same metal layer; and
second global data lines, which are disposed between the first global data lines and are formed as different metal layers from the first global data lines.

11. A display driver integrated circuit (IC) for driving a display device, the display driver IC comprising:
a memory unit to store data;
local data lines connected to data ports of the memory unit;
global data lines connected to the local data lines to be switched thereto and to provide data that are received through the local data lines to a logic circuit, so that the display device can be driven;
a first switching unit disposed on the local data lines to control transmission of data that are output from the memory unit; and
a second switching unit disposed between the local data lines and the global data lines to transmit data that are received from the local data lines to the global data lines.

12. The display driver IC of claim 11, wherein the memory unit comprises m×n output ports for outputting m×n bit data (where m and n are integers), and the first switching unit comprises first through n-th switching groups, and each of the first through n-th switching groups comprises m switches.

13. The display driver IC of claim 12, wherein the second switching unit comprises first through x switching groups (where x is an integer), and each of the first through x switching groups of the second switching unit comprises m switches, and each of the first through x switching groups of the second switching unit is electrically connected to (n/x) switching groups of the first switching unit, and data that are received from each of the (n/x) switching groups of the first switching unit are sequentially transmitted to the global data lines.

14. The display driver IC of claim 13, wherein each of switches included in the first switching unit and the second switching unit comprises:
a transmission gate; and
an inverter inverting control signals that are used to control the transmission gate.

15. The display driver IC of claim 13, wherein, when one of the first through n-th switching groups of the first switching unit is enabled, the other switching groups are disabled, and when one of the first through x-th switching groups of the second switching unit is enabled, the other switching groups are disabled.

16. The display driver IC of claim 11, wherein the memory unit comprises a plurality of memory, and the global data lines are electrically connected to the plurality of memory, and the display driver IC further comprises buffers disposed on the global data lines and connected between nodes through which data read by first memory are transmitted and nodes through which data read by second memory adjacent to the first memory are transmitted.

17. The display driver IC of claim 11, wherein the global data lines comprise:
first global data lines, which are not adjacent to one another and are formed as the same metal layer; and
second global data lines, which are disposed between the first global data lines and are formed as different metal layers from the first global data lines.

18. A method of operating a display driver integrated circuit (IC), the method comprising:
sequentially enabling first through a-th switching groups (where a is an integer) of a first switching unit and transmitting data that are read by the memory unit through a plurality of local data lines;
enabling a first switching group of a second switching unit commonly connected to the first through a-th switching groups of the first switching unit and transmitting data that are received through the local data lines to a plurality of global data lines; and
providing the data to a logic circuit for processing of the data through the global data lines.

19. The method of claim 18, further comprising:
after sequentially enabling the first through a-th switching groups of the first
switching unit, sequentially enabling (a+1)-th (2×a)-th switching groups and transmitting data corresponding to the (a+1)-th (2×a)-th switching groups through the local data lines; and
enabling a second switching group of the second switching unit commonly connected to the (a+1)-th (2×a)-th switching groups of the first switching unit and transmitting data that are received through the local data lines to the global data lines.

20. The method of claim 19, wherein, when one of the switching groups of the first switching unit is enabled, the other switching groups are disabled, and when one of the switching groups of the second switching unit is enabled, the other switching groups are disabled.

21. A display driver integrated circuit apparatus comprising:
a memory unit to store data, and having a plurality of groups of ports, each group of ports having a predetermined number of ports to correspond to a predetermined number of bits of the data, wherein the memory unit outputs the predetermined number of bits of the data in parallel through each groups of ports and sequentially outputs the data through the respective groups of ports in a unit of the predetermined number of bits of the data;
a first switching unit having a plurality of groups of first switching elements, wherein the each group of first switching elements receives the predetermined number of bits of the data in parallel from the respective groups of ports of the memory unit, and the groups of first switching elements sequentially transmit the predetermined number of bits of the data; and
a second switching unit having a second switching element to selectively receive the data of the predetermined number of bits from the respective groups of first switching elements of the first switching unit, and to transmit the received data of the predetermined number of bits in parallel.

22. The display driver integrated circuit apparatus of claim 21, wherein:
the memory unit comprises a plurality of another groups of another ports, each group of ports having a predetermined number of ports to correspond to a predetermined number of bits of the data, wherein the memory unit outputs the predetermined number of bits of the data in parallel through each of another groups of another ports and sequentially outputs the data through the respective ones of another groups of another ports in a unit of the predetermined number of bits of the data;
the first switching unit comprises a plurality of another groups of first switching elements, wherein the each of another groups of first switching elements receives the predetermined number of bits of the data in parallel from the respective ones of anther groups of another ports of the memory unit, and the another groups of first switching elements sequentially transmit the predetermined number of bits of the data; and
the second switching unit comprises a second switching element to selectively receive the data of the predetermined number of bits from the respective groups of another switching elements of the first switching unit, and to transmit the received data of the predetermined number of bits in parallel.

23. A display driver integrated circuit apparatus comprising:
a memory unit to store data, and having a plurality of groups of ports;
a first switching unit having a plurality of groups of first switching elements to receives the predetermined number of bits of the data in parallel from the respective groups of ports of the memory unit, and to sequentially transmit the predetermined number of bits of the data;
local data lines to connect the respective ports of the memory unit to the corresponding first switching elements of the first switching unit;
a second switching unit to selectively receive the data of the predetermined number of bits from the respective groups of first switching elements of the first switching unit, and to transmit the received data of the predetermined number of bits in parallel; and
global data lines connected to the second switching unit to transmit the data received from the second switching unit in parallel.

24. A display driver apparatus comprising:
a memory unit to store data, and having a plurality of ports to output the date; and
a switching unit to receive data of a predetermined bits from each group of ports in parallel, to sequentially receive each parallel data of predetermined bits from respective groups of ports, and to selectively output the sequentially received parallel data of the predetermined bits.

25. The display driver apparatus of claim 24, wherein:
the switching unit comprises:
a first switching unit to receive data of a predetermined bits from each group of ports in parallel, to sequentially receive each parallel data of predetermined bits from respective groups of ports, and
a second switching unit to selectively output the sequentially received parallel data of the predetermined bits; and
the first switching unit and the second switching unit are connected in series from the memory unit through corresponding data lines.

26. The display driver apparatus of claim 25, further comprising:
local data lines connected between the memory and the first switching unit; and
another data lines connected between the local data lines and the second switching unit.

27. The display driver apparatus of claim 26, wherein the local data lines do not overlap each other, and the another data lines overlap each other.

28. The display driver apparatus of claim 26, wherein the local data lines are disposed on a same layer, and the another data lines are disposed on different layers, with respect to the memory unit.

29. A display apparatus comprising:
a display driver integrated circuit apparatus comprising:
a memory unit to store data, and having a plurality of ports to output the date; and
a switching unit to receive data of a predetermined bits from each group of ports in parallel, to sequentially receive each parallel data of predetermined bits from respective groups of ports, and to selectively output the sequentially received parallel data of the predetermined bits;
a source driving unit to generate image data according to the data from the global data lines; and
a display panel to display an image according to the image data.
